(19) United States
(12) Patent Application Publication
(10) Pub. No.: US 2026/0349241 A1
(43) Pub. Date: Nov. 5, 2026

(54) DYNAMIC ADAPTIVE SHADING SYSTEM

(71) Applicant: Eric Ingram, Alexandria, VA (US)

(72) Inventor: Eric Ingram, Alexandria, VA (US)

(21) Appl. No.: 19/198,212

(22) Filed: May 5, 2025

(51) Int. Cl. G02B 26/02; G01J 1/02; G01J 1/42; G02B 27/00

(52) U.S. Cl. CPC G02B 26/023; G01J 1/0238; G01J 1/0242; G01J 1/42; G02B 27/0093; G01J 2001/4266

(57) ABSTRACT

A dynamic sun shading system adapted to provide shading of light passing through a see-through material. The system includes a see-through material. The system includes precision sensors embedded in the see-through material to sense the light to be shaded. The system includes an optical control system embedded in the see-through material to provide shading of the light when activated. The system includes a computer to control the optical control system and computer vision algorithms with real-time response process by the computer to control the optical control system.

### BACKGROUND

The field of invention generally relates to a real-time dynamic sun protection using precision sensors and advanced optical control systems. More specifically, the present invention relates to the shading of see through material used by humans in a specific area of the material based on the position of the sun.

Traditionally, Auto darkening sunglasses, shades windows are ways to block the sun from a person's vision. All of these are a see-through material used to deter the sun from being in the direct vision of a user. When used, the whole of the see-through material is darkened, which may not be desirable or effective.

It is an object of the present invention to provide a real-time dynamic sun shading system that darkens a see through material in a specific location of the material.

### SUMMARY OF THE INVENTION

A dynamic sun shading system adapted to provide shading of light passing through a see-through material. The system includes a see-through material. The system includes precision sensors embedded in the see-through material to sense the light to be shaded. The system includes an optical control system embedded in the see-through material to provide shading of the light when activated. The system includes a computer to control the optical control system and computer vision algorithms with real-time response process by the computer to control the optical control system.

### BRIEF DESCRIPTION OF DRAWINGS

FIG. 1 is a perspective view of a dynamic sun shading system applied to sunglasses according to the present invention.

FIG. 2 is a perspective view of a dynamic sun shading system applied to a windshield according to the present invention.

FIG. 3 is a perspective view of a dynamic sun shading system applied to a helmet according to the present invention.

FIG. 4 is a front view of sunglasses according to the present invention.

FIG. 5 is a front view of sunglasses with applied shading of a dynamic sun shading system according to the present invention.

FIG. 6 is a perspective view of a dynamic sun shading system applied to a building window according to the present invention.

FIG. 7 is a schematic of components connected to a computer according to the present invention.

FIG. 8 is a schematic example of software and the software's interaction with components according to the present invention.

### DETAILED DESCRIPTION

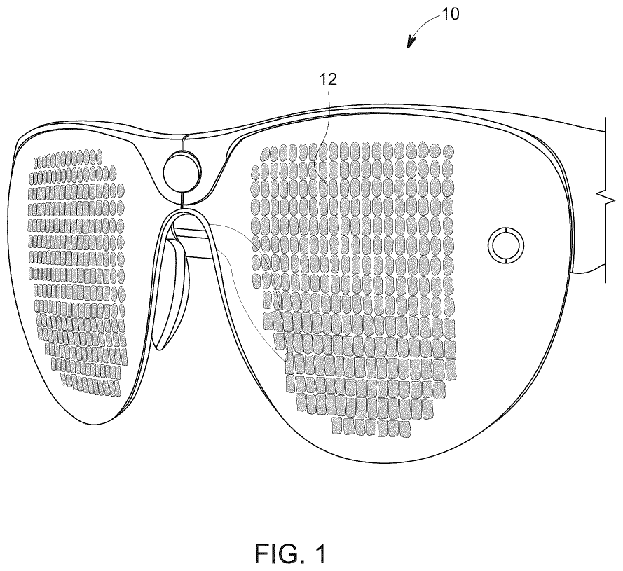

The dynamic sun shading system provides real-time sun protection through the use of precision sensors and advanced optical control systems with a 2D surface of a see-through material 10, as shown in FIGS. 1-6. The system includes forward-facing sensors to track the position of the sun and inward-facing sensors to monitor the position of a desired location. By mapping the sun's location relative to the desired location, the opacity of the see-through material is adjusted for the user. The system uses the integration of computer vision and real-time response algorithms to ensure accurate and efficient shading adjustments. The shading of the see-through material is performed only along certain portions of the material with respect to the sun and the desired position, blotting out only the sun as it relates to the user or an object. The system can also be used to shade bright object or lights, therefore for future reference any bright object or light will just be referred to as the sun. So the see-through material is not shaded in its entirety. This effect is similar to holding a user's hand in front of their face to block the sun and see everything else. On see-through material the system can apply the shading to multiple segments of the material, if needed by the user.

As examples, the dynamic sun shading system can be integrated into the see-through material of sunglasses, windshields, and helmet visors, as shown in FIGS. 1-3. The system incorporates forward-facing sensors to track the position of the sun and inward-facing sensors to monitor the user's eye position and gaze direction. By mapping the sun's location relative to the user's eyes, the system adjusts the opacity of specific regions on the material in real time to block direct sunlight and reduce glare, regardless of the user's orientation or environmental conditions.

The core functionality of the system relies on the integration of computer vision and real-time response algorithms as part of the see-through material to ensure accurate and efficient shading adjustments. The system can utilize a two dimensional grid 12 of opacity changing devices such as optical shutters embedded into the see-through material. Where the optical shutters act as pixels in the see-through material that are either transparent or opaque based on the setting. The opacity changing devices can darken certain areas of the see-through material to ‘blot’ the sun relative to a specific position in the see-through material desired by the user. The optical shutter grid can be incorporated on flat or curved surfaces, and may be placed between other panels of glass or optical layers. This approach offers seamless sun protection and adaptability without the need for complex artificial intelligence (AI) systems. However, AI can be incorporated optionally to enhance performance by enabling predictive light adjustment and creating customizable operational schemes for specific use cases or environments.

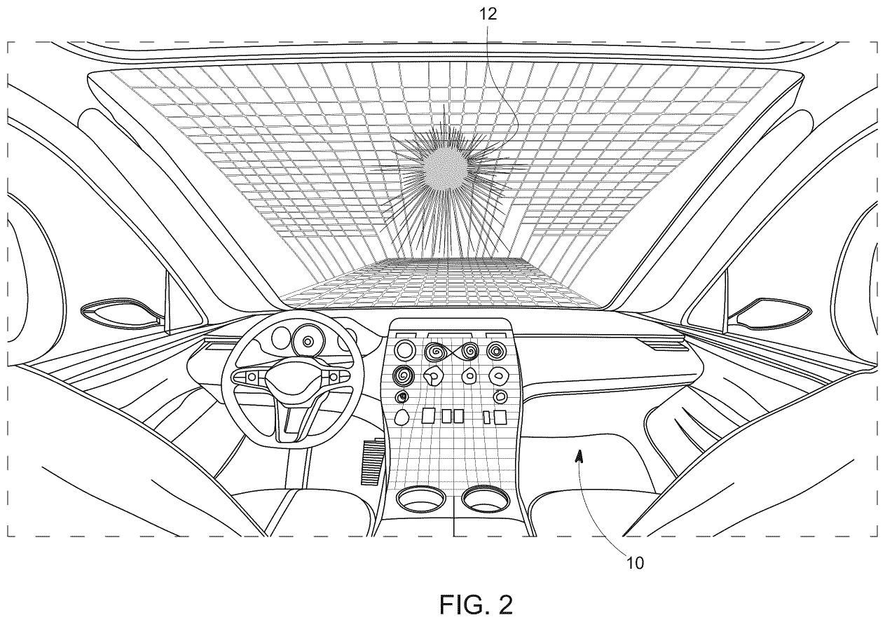

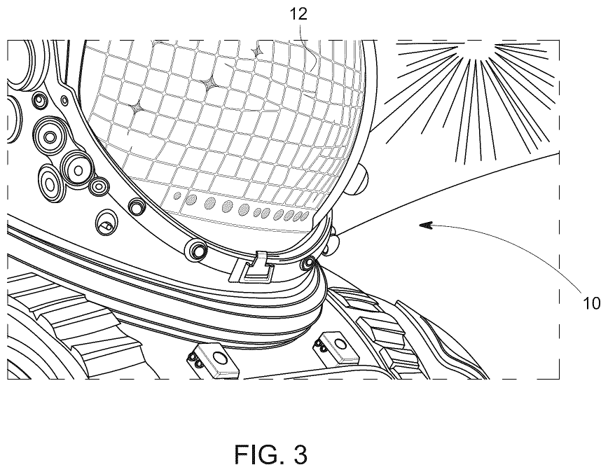

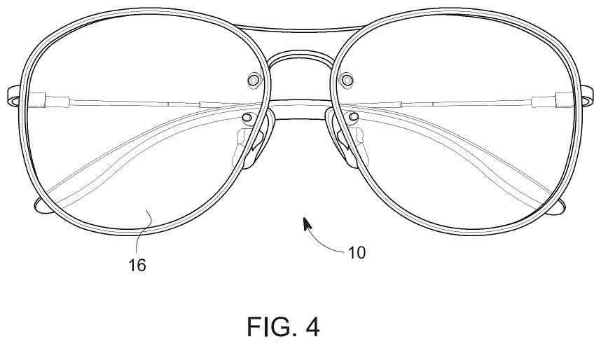

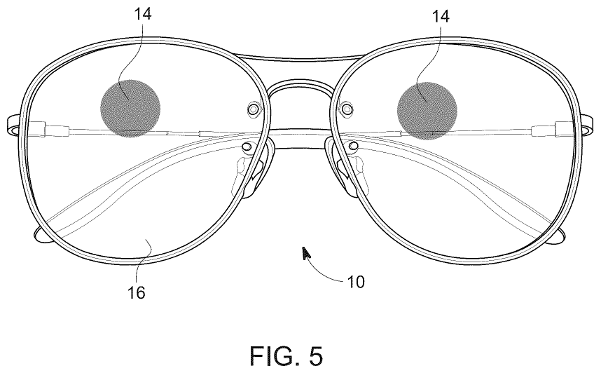

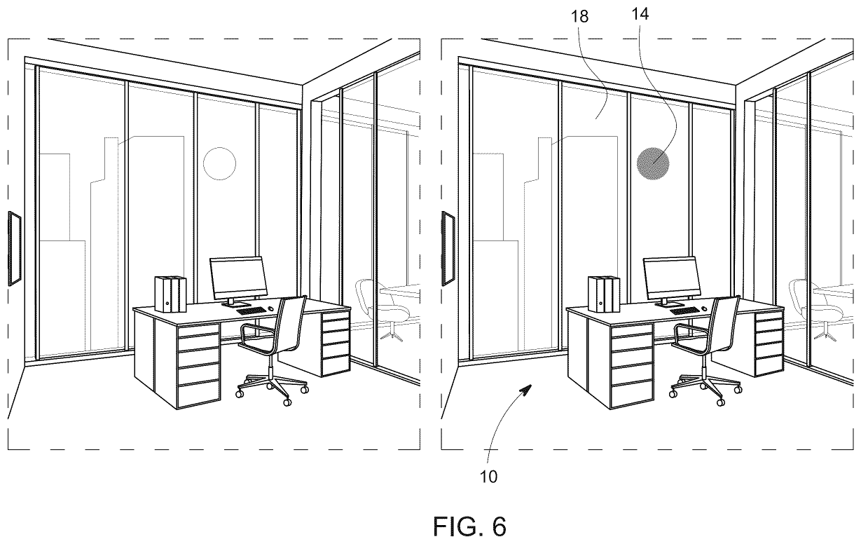

The system is highly adaptable and can be applied to various applications. The system can be used with sunglasses, as shown in FIG. 1 with a mapping of the precision sensors and advanced optical control systems. The system can be used with windshields in road vehicles, boats, trains, and airplanes, where it enhances visibility and reduces glare for operators and passengers, as shown in FIG. 2 with a mapping of the precision sensors and advanced optical control systems. The system can be implemented as part of helmet visors for motorcyclists, aviators, and industrial workers, as well as in goggles for sports, safety, and medical applications, as shown on a helmet in FIG. 3 with a mapping of the precision sensors and advanced optical control systems. For sunglasses, FIG. 4 shows sunglasses which are not engaged with sunlight. FIG. 5 shows darkened spots 14 on the sunglasses, where the darkened spots of the lens would be in reference to the sun position relative to the user's eyes. The system can also be integrated into architectural windows, offering dynamic transparency adjustments to reduce glare, improve comfort, and optimize energy efficiency in buildings, as shown in FIG. 6. FIG. 6 shows an example of darken spots 14 on a window 18. In a vehicle setting a portion of the windshield of the vehicle would darken in relation to the sun and position of the face of the user. In an infrastructural setting a portion of a window would darken relative to the position of object(s) in a room, such as a computer screen to minimize glare without darkening the whole room.

The integration of AI with the system would enhance ability of the system to predict light conditions and refine the shading process, offering a seamless, personalized, and effective solution for sun protection across a wide range of environments and applications. The dynamic sun shading system for enhanced sun protection and glare reduction delivers an effective, versatile, and scalable solution for managing sunlight and glare across a broad range of environments and industries.

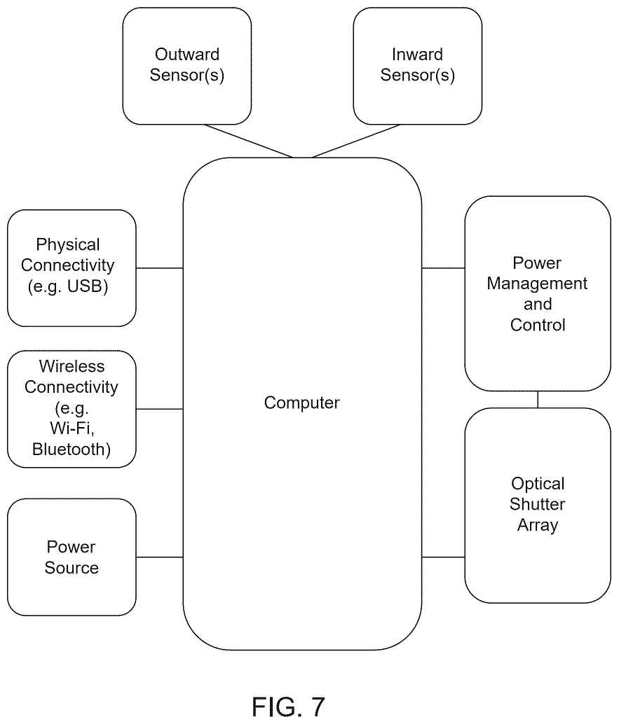

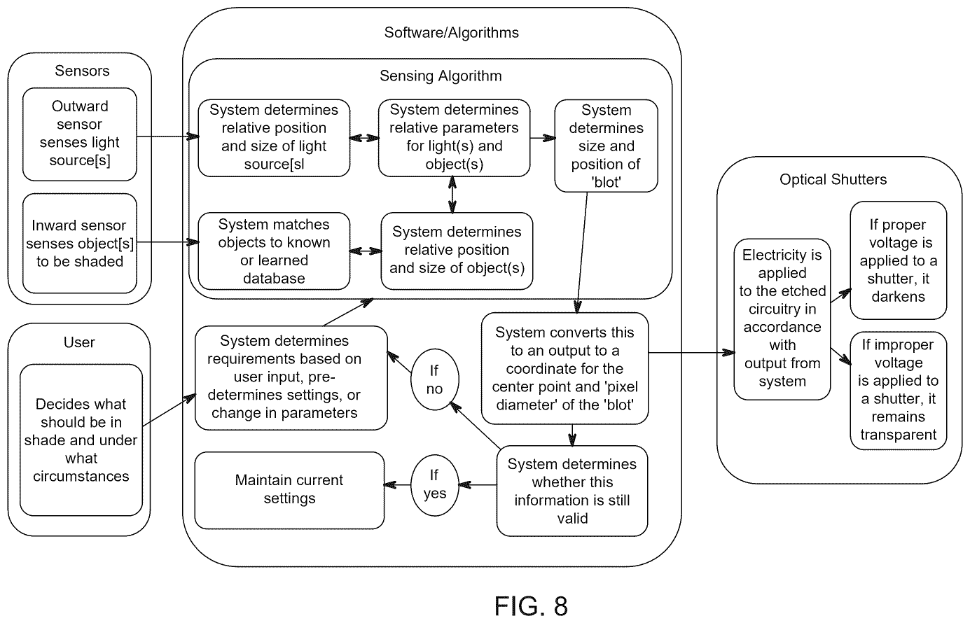

There is a variability to how software can be implemented as part of the dynamic sun shading system. With that in mind a layout of the processes software would follow is described. The system incorporates heavy usage of Computer Vision (CV) software and algorithms, which will be encompassed throughout process description. FIG. 7 shows a schematic of the components connected to a computer that would implement the software. FIG. 8 shows a schematic one example of the software and the software's interaction with the components. The sun would be sensed by the outward-facing sensor, which would then have its position evaluated relative to that sensor's location and there is a correlating to a calibration. The system will also use CV techniques, such as blob detection for example, to determine the relative size of the sun. Through an application accessed by the user, there will be a determination made as to what object or objects the user would like to remain shaded, such as a person or a computer monitor. Through machine learning or AI training, the system will be able to discern most common objects and features, and should easily recognize the objects desired to be in shade using its inward-facing sensors and incorporated software/algorithms/computer.

If the user were to determine they would like their computer monitor to remain in shade, while the rest of the room remains sunlit, they would indicate that via their application or access process. The system would compute the angle of the sun relative to the object to-be-shaded and position the center of the ‘blot’ based on the angle. The system will also determine how big the ‘blot’ needs to be based on the size of the light source at the time, and the size of the area or object to-be-shaded. The system will then size the ‘blot’ accordingly to ensure coverage of the object in shade, and to minimize the amount of the window which needs to be ‘blotted’. The system will then track the sun throughout the day, and maneuver, position, and resize the ‘blot’ as needed to maintain the desired shading of the object. If at any point another light source is present that passes the threshold of needing ‘blotting’, such as a sudden reflection of the sun from another building as it tracks through all or part of the day, the system will implement the same process to add in additional ‘blots’. The user can determine the upper limit of blots desired if additional blotting is not needed or wanted. If the user wanted to blot a person instead the process would be similar, with the system tracking the position of the person as they move about the room and moving/sizing the blot(s) as necessary. The same can be said for a combination of a static object (such as the computer monitor) and a dynamic object (such as a person). For uncommon objects, or refinement, the system can be trained to recognize them using CV, ML, and AI methodologies to update the algorithms to accommodate those new objects, or to perform its operations more accurately.

While different embodiments of the invention have been described in detail herein, it will be appreciated by those skilled in the art that various modifications and alternatives to the embodiments could be developed in light of the overall teachings of the disclosure. Accordingly, the particular arrangements are illustrative only and are not limiting as to the scope of the invention that is to be given the full breadth of any and all equivalents thereof.

I claim:

1. A dynamic sun shading system adapted to provide shading of light passing through a see-through material, comprising of:
a see-through material;
precision sensors embedded in said see-through material to sense the light to be shaded;
optical control system embedded in said see-through material to provide shading of the light when activated;
a computer to control said optical control system; and
computer vision algorithms with real-time response process by said computer to control said optical control system.

2. The system of claim 1, further including forward-facing sensors adapted to track position of the light to be shaded.

3. The system of claim 1, further including inward-facing sensors adapted to monitor the position of a desired location of said see-through material to be shaded.

4. The system of claim 2, wherein said computer vision algorithms are adapted to map the light to be shaded relative to a desired location of said see-through material, wherein opacity of said see-through material is adapted to be adjusted for a user.

5. The system of claim 1, wherein said computer vision algorithms can manipulate the optical control system to shade said see-through material along certain portions of the material with respect to the light and the desired position to be shaded so said see-through material is not shaded in its entirety.

6. The system of claim 5, wherein said computer vision algorithms can manipulate the optical control system to shade said see-through material in multiple segments to provide shading in different areas of said see-through material while not shading other areas.

7. The system of claim 1, wherein said optical control system is a two dimensional grid of opacity changing devices.

8. The system of claim 7, wherein optical shutters are embedded into said see-through material as part of said optical control system and said optical shutters act as pixels in said see-through material that are either transparent or opaque based on said computer vision algorithms.

9. The system of claim 7, wherein said opacity changing devices can darken certain areas of said see-through material to ‘blot’ the light relative to a specific position in the see-through material to be shaded.

10. The method for shading a see-through material with a system having precision sensors embedded in said see-through material to sense the light to be shaded and an optical control system embedded in said see-through material to provide shading of the light when activated; comprising:
using Computer Vision (CV) software and algorithms to sense light to be shaded using an outward-facing sensor; and
using the Computer Vision (CV) software and algorithms accessed by a user to make determination object the user wants to shaded the see-through material 11. The method of claim 10, wherein evaluating area to be shaded to the sensor's location the CV provides a correlating calibration.

12. The method of claim 10, further using CV techniques of blob detection to determine the relative size of the light source and through an application accessed by the user making determination made as to what area of the see-through material is shaded.

13. The method of claim 12, wherein the system computes the angle of the light to a object to-be-shaded and position a center of a blot based on the angle and wherein the system also determines how big the ‘blot’ needs to be based on the size of the light source at the time, and the size of the area to be shaded and wherein the system sizes the blot accordingly to ensure coverage of an object in shade and to minimize the amount of area which needs to be blotted.

14. The method of claim 13, wherein the system tracks the light source throughout a time period to maneuver, position, and resize the blot as needed to maintain the desired shading.
